(19) United States
(12) Patent Application Publication
(10) Pub. No.: US 2008/0135182 A1
(43) Pub. Date: Jun. 12, 2008

(54) SURFACE MOUNTING APPARATUS

(75) Inventor: Takashi Nishikawa, Tokyo (JP)

Correspondence Address: SIERRA PATENT GROUP, LTD., 1663 Hwy 395, Suite 201, Minden, NV, 89423, US

(73) Assignee: JUKI CORPORATION, Tokyo (JP)

(21) Appl. No.: 11/952,450

(22) Filed: Dec. 7, 2007

(30) Foreign Application Priority Data
Dec. 8, 2006 (JP) P2006-332257

(51) Int. Cl. B29C 65/72

(52) U.S. Cl. 156/536

(57) ABSTRACT

In a surface mounting apparatus having a pair of substrate fixing portions disposed opposite to each other and serving to support and fix opposed ends of a substrate respectively and a mounting head for mounting a component held by an attached nozzle on the substrate which is supported and fixed by the substrate fixing portion, including an air injecting portion disposed close to the substrate fixing portion and serving to inject air like a curtain from an outside of the substrate which is supported and fixed above an upper surface of the substrate, and an air suctioning portion disposed close to the other substrate fixing portion and serving to suction the air at the outside of the substrate which is opposed to an ejecting direction of the air.

### CROSS-REFERENCE TO RELATED APPLICATIONS

The present invention claims priority from Japanese Patent Application No. 2006-332257 filed on Dec. 8, 2006, the entire content of which is incorporated herein by reference.

### BACKGROUND OF INVENTION

1. Field of the Invention

The present invention relates to a surface mounting apparatus capable of preventing powder dust caused by a mounting operation from sticking to a substrate or an electronic component (a device) when mounting the electronic component onto the substrate.

2. Description of the Related Art

By using a surface mounting apparatus, generally, a component held in a nozzle attached to a mounting head is mounted onto a substrate placed and fixed into a predetermined position. Thus, a mounting substrate is produced.

In the production of the substrate, it is important to hinder powder dust (dust) from sticking to the substrate or the component in order to prevent the generation of a defective product in the production of the substrate.

As a method of preventing the dust from sticking to the produced substrate, conventionally, a surface mounting apparatus is provided in a clean room and a whole producing environment is brought into a state in which an amount of the dust is very small, and the production is thus carried out.

As disclosed in JP-A-10-020478, moreover, there has been known a method of providing, in a ceiling portion of a producing apparatus, an apparatus for generating clean air through an HEPA (High Efficiency Particulate Air) filter and causing the clean air from flowing down from the apparatus and filling an inner part of the producing apparatus with the clean air.

In the conventional method of providing the surface mounting apparatus in a clean room, however, a mounting head is moved in an X-Y direction at a high speed above the substrate when an electronic component is mounted onto the substrate. For this reason, the dust is generated due to the operation in some cases. The dust is generated in the surface mounting apparatus. Therefore, there is no effect even if an environment around the surface mounting apparatus is made clean.

Also the method of causes the clean air to flow down from the ceiling portion of the producing apparatus and prevents sticking. Moreover, a destination of the generated dust diffuse random in an apparatus by stirring an air flow therein because of a mounting head moved at a high speed. Therefore, the method is not an effective solution.

### SUMMARY OF INVENTION

One or more embodiments of the invention provide surface mounting apparatus which reliably prevents dust generated in the surface mounting apparatus due to a mounting operation from sticking to a substrate.

According to a first aspect of the invention, a surface mounting apparatus provides a pair of substrate fixing portions, each of the substrate fixing portions being opposed to each other to support and fix opposing ends of a substrate respectively, a mounting head which is movable in a vertical direction to mount a component on the substrate supported and fixed by the substrate fixing portions, an air ejecting portion disposed close to one of the substrate fixing portions to eject air like a curtain from an outer side and above an upper surface of the substrate, and an air suctioning portion disposed close to the other substrate fixing portion so as to oppose to an ejecting direction of the air at an opposite side of the air ejecting portion with respect to the substrate to suction the air from the air ejecting portion.

According to a second aspect of the invention, the air ejecting portion ejects the air along the upper surface of the substrate.

According to a third aspect of the invention, the air ejecting portion comprises a hollow cylindrical member having both ends opened, wherein ejecting holes, from which the air is ejected, are formed on the hollow cylindrical member at predetermined intervals in a longitudinal direction of the hollow cylindrical member, wherein an air blowout range of the ejecting holes covers the entire upper surface of the substrate supported and fixed by the substrate fixing portions.

According to a fourth aspect of the invention, the mounting head comprises a holding member which removable holds the component, wherein the surface mounting apparatus further comprises a controller which stops an ejection of the air from the air ejecting portion when the holding member is positioned within a blowout range of the air while mounting the component onto the substrate.

According to a fifth aspect of the invention, the controller may stops the ejection of the air from the air ejecting portion before the holding member passes through an ejection flow of the air from above, and starts the ejection of the air from the air ejecting portion after the component is mounted and after the holding member passes through the ejection flow of the air from below.

According to a sixth aspect of the invention, the controller stops the ejection of the air from the air ejecting portion before the holding member is moved downward into the blowout range of the air.

According to a seventh aspect of the invention, the controller stops the ejection of the air from the air injecting portion when a movement of the holding member in a horizontal direction is stopped.

According to an eighth aspect of the invention, the controller simultaneously stops a suction of the air suctioning portion and the ejection from the air injecting portion.

According to a ninth aspect of the invention, at least one of the air ejecting portion and the air suctioning portion is fixed to the substrate fixing portions.

According to a tenth aspect of the invention, the air ejects like a curtain from the air ejecting portion.

According to the invention, since the air is injected like a curtain from the outside of the substrate by the air injecting portion above the upper surface of the substrate, and furthermore, the air thus ejected is suctioned by the suctioning portion disposed opposite, a curtain-like air flow (ejection flow) may be reliably formed along the upper surface with the substrate interposed therebetween and dust generated in the apparatus by the air flow may be prevented from being dropped onto the substrate. Therefore, it is possible to reliably prevent the dust from sticking to the substrate.

When the holding member such as a nozzle for holding the component is positioned in the air curtain, moreover, the air is stopped. Therefore, it is possible to prevent the component held in the holding member from being shifted by the air, and furthermore, to hinder a turbulence of the air from being caused by positioning the holding member within the air blowout range and to prevent outside dust from flowing in due to the turbulence or dust from being blown onto the substrate.

### BRIEF DESCRIPTION OF THE DRAWINGS

FIG. 1 is a schematic sectional view showing a substrate fixing portion of a surface mounting apparatus according to a first embodiment of the invention,

FIG. 2 is a perspective view showing an enlarged bar nozzle,

FIG. 3 is a block diagram schematically showing a control system,

FIG. 4 is a flowchart showing an action,

FIG. 5 is a timing chart showing the action,

FIG. 6 is a sectional view showing a state brought immediately before a component is mounted,

FIG. 7 is a sectional view showing a state brought immediately after the component is mounted,

FIG. 8 is a schematic sectional view showing a surface mounting apparatus according to a second embodiment of the invention, and

FIG. 9 is a schematic sectional view showing a surface mounting apparatus according to a third embodiment of the invention.

### DETAILED DESCRIPTION

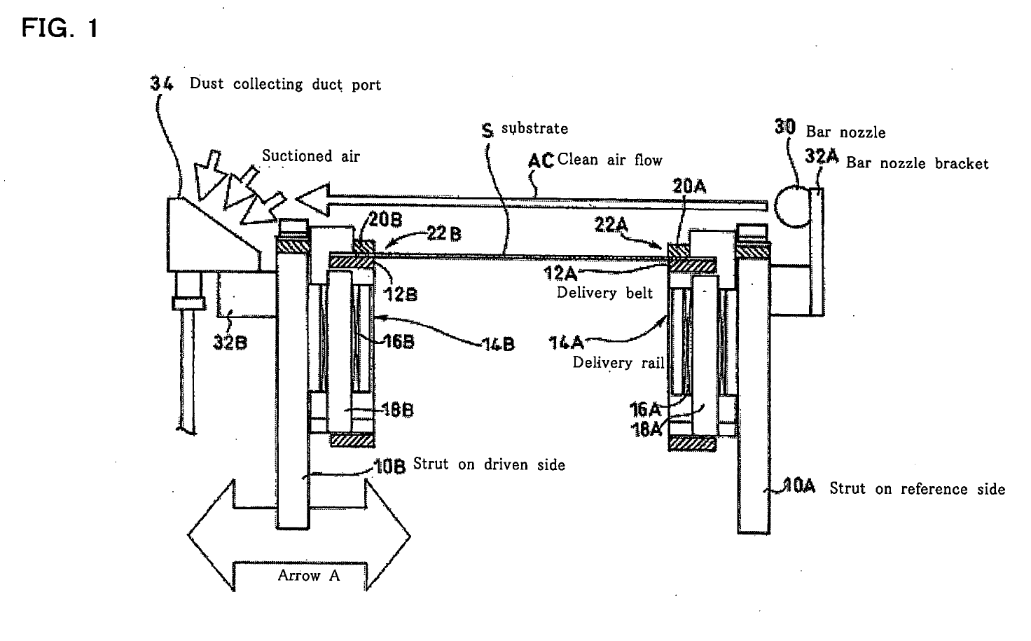

FIG. 1 is a schematic sectional view showing a substrate fixing portion of a surface mounting apparatus according to a first embodiment of the invention.

The substrate fixing portion is a component mounting portion for fixing a substrate to mount a component thereon and constitutes a part of an apparatus for delivering a substrate S for mounting the component thereon.

The substrate delivering apparatus includes a strut 10A on a reference side which is fixed, and another strut 10B on a driven side which is disposed so as to oppose to the strut 10A and is movable in a direction A in accordance with a dimension of the substrate S to be delivered.

Delivery rails 14A and 14B on the reference and driven sides around which non-end delivery belts 12A and 12B are wound in a delivery direction are supported on the struts 10A and 10B so as to be vertically movable through guides 18A and 18B to be guided to direct driving bearings 16A and 16B, respectively.

Moreover, clamp members 20A and 20B are fixed to upper ends of the struts 10A and 10B, and the substrate fixing portion is formed by the clamp members 20A and 20B and the delivery rails 14A and 14B. The delivery rails 14A and 14B are moved upward to fix the substrate S.

More specifically, a pair of clamp mechanisms (substrate fixing portion) 22A and 22B support and fix opposed ends of the substrate S respectively and disposed opposite to each other. The clamp mechanisms 22A and 22B are formed by the delivery belts 12A and 12B wound around the delivery rails 14A and 14B to be vertically moved and the clamp members 20A and 20B fixed to the corresponding struts 10A and 10B.

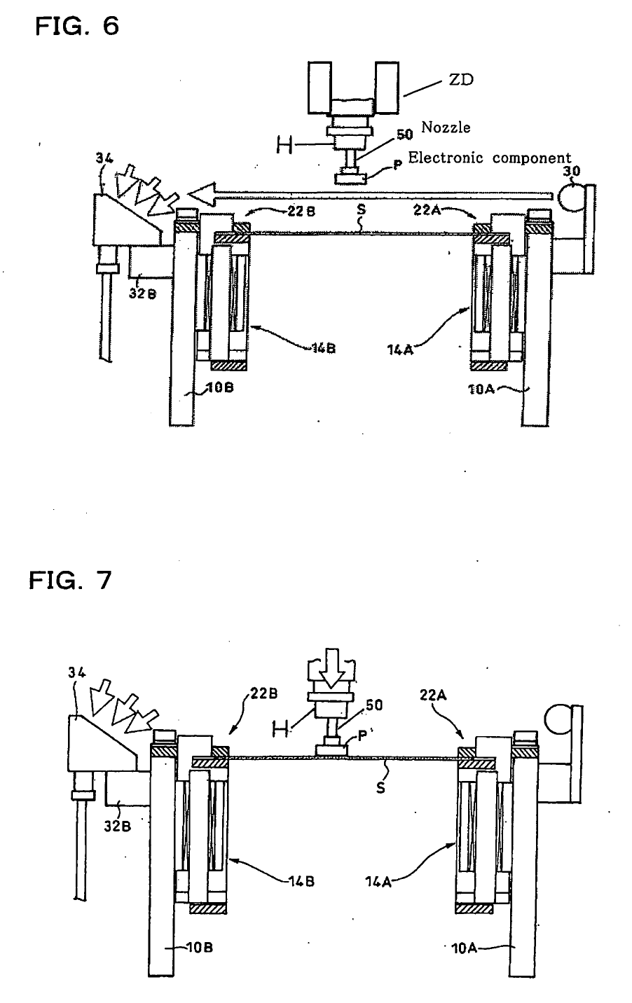

In the surface mounting apparatus, moreover, a mounting head H having a nozzle (holding member) 50 is disposed movably in an XY-axis direction (a horizontal direction) by the driving operation of pulse motors (X-axis and Y-axis motors) (not shown) above the substrate S supported and fixed by the clamp mechanisms 22A and 22B. Moreover, the mounting head H may be vertically moved by a pulse motor (a Z-axis motor) ZD in a Z-axis direction (a vertical direction). By the driving operations, a component adsorbed and held by the holding member 50 is mounted onto the substrate S. The Z-axis motor ZD is described in only FIG. 6 and is not shown in FIGS. 7 and 9.

A bar nozzle (air ejecting portion) 30 is disposed close to the clamp mechanism 22A on a reference side, and positioned above the upper surface of the substrate S which is supported and fixed by the clamp mechanisms. The bar nozzle 30 injects air like a curtain from the outside of the substrate S along the upper surface of the substrate S which is fixed to the strut 10A by a bracket 32A.

Moreover, a dust collecting duct (air suctioning portion) 34 disposed close to the clamp mechanism 22B on a driven side, provided opposite to the air injecting direction of the bar nozzle 30 with the substrate S interposed therebetween. The dust collecting dust suctions the air at the outside of the substrate S is fixed to the strut 10B by a bracket 32B.

Accordingly, it is possible to form a curtain-like air flow (an ejection flow) AC in a leftward direction shown in an arrow in the drawing in which the air is injected at the outside from one of the ends of the substrate S interposed and fixed by the clamp mechanism 22A on a reference side through the bar nozzle 30 and the air is suctioned at the outside from the opposed ends interposed and fixed by the clamp mechanism 22B on a driven side through the dust collecting duct 34, and the air is thus prevented from being directly blown onto the substrate S.

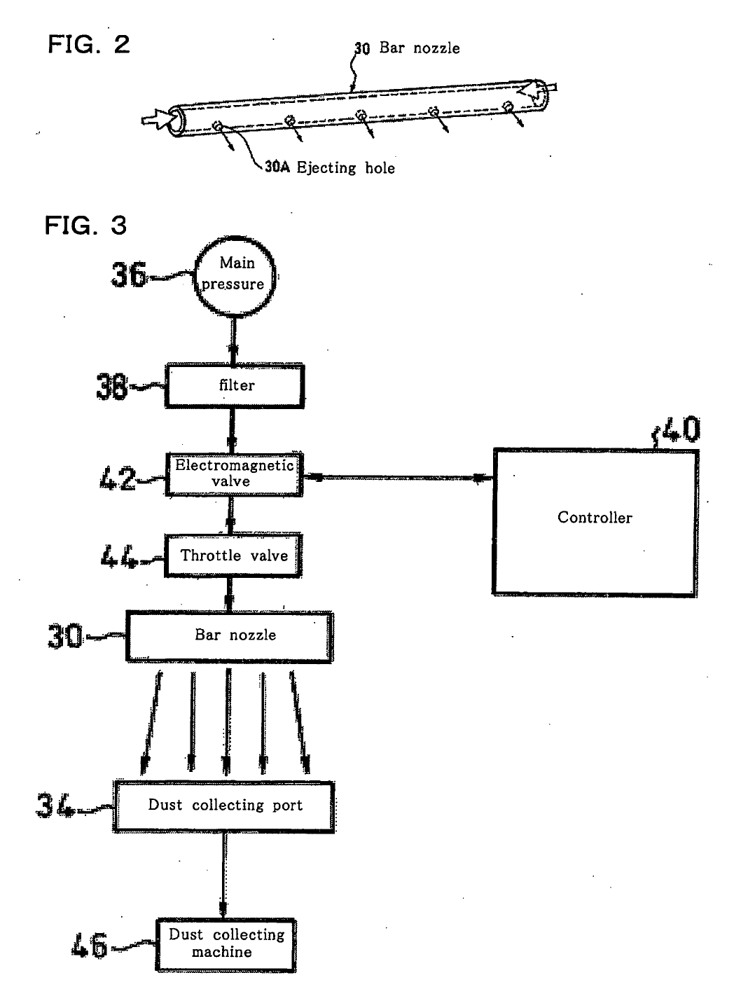

The bar nozzle 30 is formed by a straight hollow and cylindrical member having both ends opened as is enlarged in FIG. 2, and has such a structure as to form an injecting hole 30A for blowing the air out rectilinearly at a predetermined interval in a longitudinal direction thereof.

In the bar nozzle 30, an air blowout range obtained by the injecting hole 30A is formed in a length in the delivery direction of the clamp mechanisms 22A and 22B. That is, the length which may generate a curtain-like air flow (hereinafter, an air curtain) having a width for substantially covering the whole upper surface over the substrate having a maximum size.

Therefore, the injecting hole (a lateral hole) 30A of the bar nozzle 30 injects clean air in a lateral direction above the outside of the produced substrate S in an upper position of the substrate S. Therefore, A dust dropped from above is carried on a flow of the clean air (the air curtain) and is thus transported, and is caught by a flow of the suctioned air which is generated by a dust collecting machine in the vicinity of the dust collecting duct 34, and is taken into an inner part of the dust collecting machine.

Accordingly, a direction of the blowout of the clean air may be turned in a horizontal direction or slightly upward therefrom in consideration of a drip of the dust which is caused by a gravity or a spread of the air which is blown out.

Moreover, the dust collecting duct hole 34 is provided ahead of the air which is blown out, and a filtration is carried out by a filter of a dust collecting device 46 having a combination of a fan and a filter which is connected ahead of the dust collecting duct port 34.

Next, an air blowout control function of the surface mounting is described as below.

The clean air is supplied to the bar nozzle 30 through a control system shown in FIG. 3. More specifically, the clean air supplied from a compressor 36 indicated as a main pressure through an air filter 38 is supplied to the bar nozzle 30 through an electromagnetic valve 42 controlled by a controller 40 and a throttle valve 44 such as a speed control valve or a pressure reducing valve and is then injected from the injecting hole 30A arranged and formed straight on the bar nozzle 30, and furthermore, is suctioned through a dust collecting port (a suctioning port) of the dust collecting duct 34 and is treated by the dust collecting machine 46. A specific control operation to be executed by the controller 40 will be described below in detail.

The compressor 36 is an air supply source for generating a certain air pressure (a main pressure). The air supplied from the compressor 36 may be filtered into a dry and clean state through the air filter 38 via a mist separator (not shown). Referring to a step to be executed before generating the clean air, if a factory or a clean room has the function, it may be utilized. In addition, filters having different levels such as a type and a roughness are used depending on a degree of cleanliness.

The air brought into a clean state through the filter 38 passes through the electromagnetic valve 42 and is decreased in a flow rate and a pressure by the throttle valve 44, and is blown, as clean air regulated to have a necessary flow rate and pressure, straight in the lateral direction above the substrate from the bar nozzle 30, that is, upward along the upper surface of the substrate.

The clean air blown out of the bar nozzle 30 passes above the substrate in the lateral direction and is thus changed into the so-called air curtain, and may catch dust generated by an operation for moving the mounting head and dropped toward the produced substrate from above and may blow off the dust in the lateral direction.

The throttle valve 44 may be regulated in such a manner that the flow rate and the pressure may be regulated corresponding to a size of the surface mounting apparatus to be disposed, for example, a distance between the bar nozzle 30 and the dust collecting duct port 34 or an external environment.

In the execution of an operation for mounting a component onto the substrate S through the mounting head H, the air injection is stopped by the controller 40 when the mounting head H is positioned in the air curtain (the air blowout range). More specifically, there is carried out a control for stopping the injection of the air through the bar nozzle 30 before the holding member 50 holding a component P passes through the injection flow AC of the air from above and starting the injection of the air through the bar nozzle 30 after the component is mounted and the holding member 50 then passes through the injection flow AC of the air from below.

Moreover, a component supply apparatus (a component adsorbing position) is also provided with the same bar nozzle and dust collecting duct (not shown) as those shown in FIG. 1 in order to prevent powder dust from being blown up from a driving portion, and a control may be carried out in the same manner.

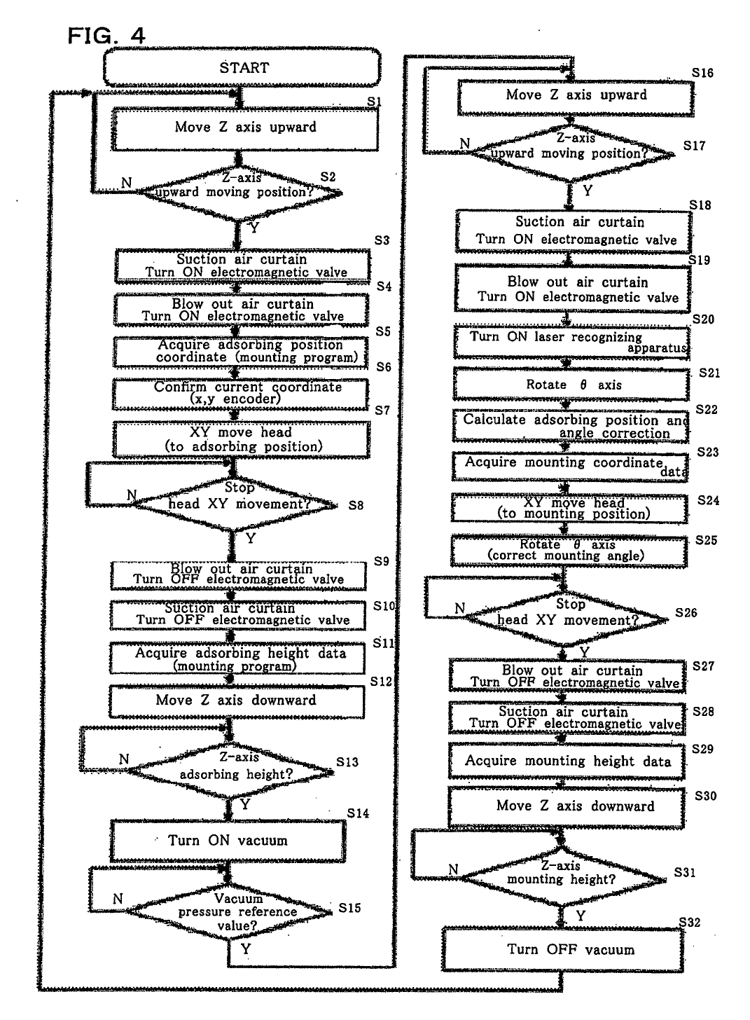

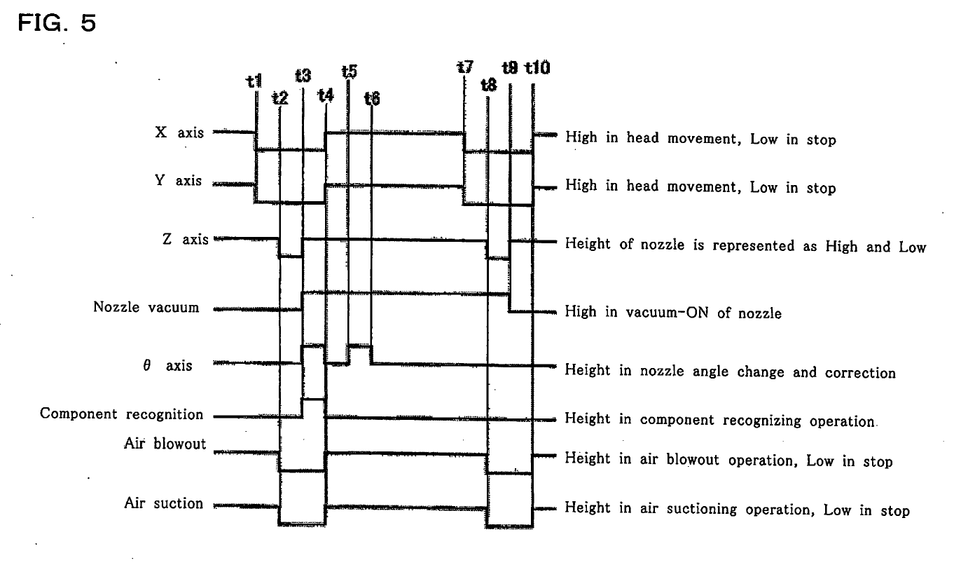

Next, a control operation is shown in a flowchart of FIG. 4 and a timing chart of FIG. 5. In the drawings, X and Y axes represent driving motors (an X-axis motor and a Y-axis motor) such as corresponding servomotors or pulse motors which serve to move the mounting head H in the respective directions, a Z axis represents the Z-axis motor ZD for vertically moving the holding member 50 on the head, and a θ axis represents a driving motor (not shown) for axially rotating the holding member 50 itself.

The detection of a stop of the X and Y axes which will be described below is carried out in software depending on the presence of a driving signal sent to both of the motors.

First of all, the holding member 50 is moved upward to a standby position by the Z-axis motor ZD (Steps 1 and 2).

Next, the suction of the dust collecting duct 34 and the blowout of the bar holding member 30 are turned ON in order to form the air curtain (Steps 3 and 4), coordinates of a component adsorbing position recorded on a program are then acquired (Step 5), coordinates in a current position are confirmed (Step 6), and the respective motors of the X and Y axes are then driven to move the mounting head H to the adsorbing position at a timing t1 (Step 7). During the XY movement of the mounting head H, powder dust is apt to be generated from a periphery of the head. Therefore, the air blowout and the air suction are turned ON to form the air curtain above the substrate S. Consequently, it is possible to prevent the powder dust from sticking to the substrate.

Upon receipt of the completion of the movement in the horizontal direction by the X-axis and Y-axis motors (Step S8), the air blowout and the air suction are stopped at t2 (Steps 9 and 10). Upon receipt of the completion of the movement through the X-axis and Y-axis motors and the stop of the air suction and blowout, the Z-axis motor ZD is operated to acquire adsorbing height data (Step 11) and to move the holding member 50 downward by the Z-axis motor ZD (Step 12). In the case in which there is no possibility that the component P might be shifted by the air curtain because a holding force (an adsorbing force) of the component P through the holding member 50 is strong, it is not necessary to stop the air.

At a time t3 that the downward movement of the holding member 50 by the Z-axis motor ZD is completed, a vacuum of the holding member is turned ON to adsorb the component P (Steps 13 to 15). Subsequently, the Z axis is moved upward. Upon receipt of the completion of the upward movement (Steps 16 and 17), the air suction and blowout is turned ON again (Steps 18 and 19). Consequently, the X and Y axes may also be moved.

In that case, a component recognizing apparatus using a laser is simultaneously turned ON (Step 20) and the holding member is rotated at θ (Step 21). Thus, a shift of a component adsorbing position of the holding member from a central position of the electronic component P is detected and an angle correcting calculation is carried out (Step 22). Subsequently, mounting coordinate data are acquired (Step 23) and the XY movement of the head is started at t4 (Step 24). At t5 to t6 during the movement, the θ axis is rotated again for the angle correction to correct a mounting angle and to correct XY coordinate values which the head is caused to reach (Step 25).

At a time t7 at which the head reaches the correction coordinates, the XY axes are stopped (Step 26). Upon receipt of the stop, the air suction and blowout is also stopped at t8 (Steps 27 and 28). At the same time, mounting height data are acquired (Step 29) to start a downward movement of the Z axis. When the downward movement to an acquiring height is completed (Steps 30 and 31), the vacuum of the holding member 50 is turned OFF to complete the mounting at a time t9 (Step 32). Then, the processing returns to the Step 1. Upon receipt of the upward movement of the Z axis at the t9, the air suction and blowout is turned ON at t10 and the movement in the XY axes is then carried out, and a movement to a next component adsorbing position is performed (Steps 2 to 7).

The device (the electronic component P) adsorbed by the holding member 50 attached to the mounting head H so as to be mounted onto the substrate S is usually adsorbed with the central position of the component P shifted from the central position of the holding member 50. Therefore, an amount of the shift is detected by image pickup through a laser beam or a camera with the component P adsorbed, and the component P is mounted at a position obtained by correcting the shift.

When the device adsorbed onto the holding member 50 passes through the flow of the clean air blown out of the bar nozzle 30 upward from the substrate S in the mounting, accordingly, there is a risk that a very small shift might be generated by the air flow (air curtain).

By the control operation, the electromagnetic valve 42 which is usually ON is turned OFF in such a timing that the mounting head H is moved to the mounting coordinates and the holding member 50 is moved downward to mount the device P onto the substrate S as shown in FIG. 6. And the blowout of the clean air upward from the substrate S may be temporarily stopped as shown in FIG. 7. In the case in which the component P is mounted onto the substrate S as shown, consequently, it is possible to prevent the generation of the positional shift of the component P due to the air.

By providing an encoder in the Z-axis motor ZD or providing a position detector in upper and lower predetermined positions of the mounting head H, the mounting head H may detect upper and lower positions placed just above and below the position of the air curtain to control the stop of the blowout of the air.

Therefore, it is possible to obtain the following advantages.

(1) The dust generated in the producing apparatus may be prevented from being dropped onto the produced substrate by causing the clean air to flow upward from the substrate, it is possible to carry out.

(2) The generated dust can be collected so as not discharge the dust outside the producing apparatus by providing the dust collecting duct is provided in the vicinity of the produced substrate.

(3) A reduction in mounting precision can be suppressed by turning OFF the clean air when mounting an electronic component.

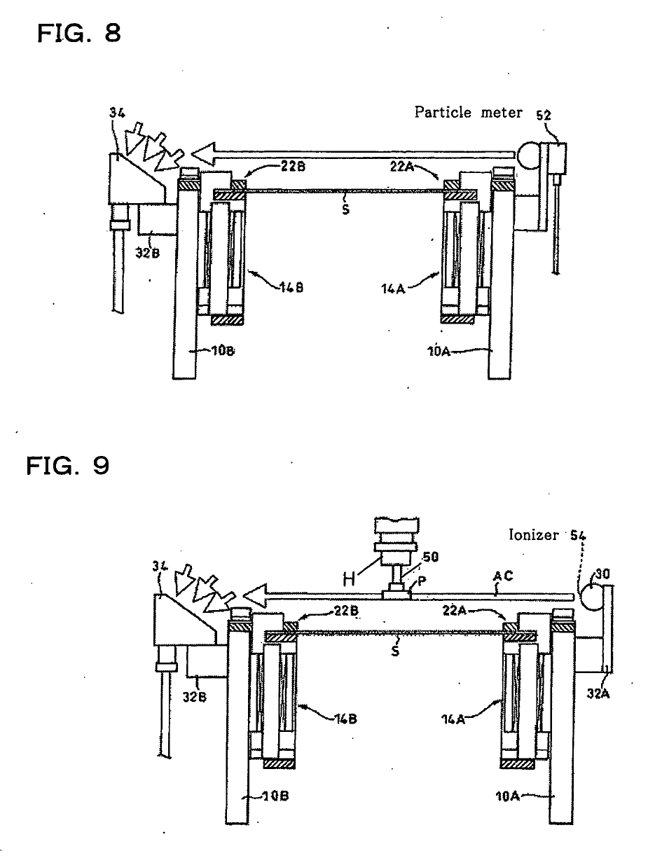

FIG. 8 shows a surface mounting apparatus according to a second embodiment of the invention.

The surface mounting apparatus has the same mechanical structure as that in the first embodiment except that a particle meter 52 is attached to a back side (the vicinity) of a bar nozzle 30.

The electromagnetic valve 42 shown in FIG. 3 is usually turned OFF so as not to blow out the air by the controller 40. In the case in which it is detected that dust exceeds a certain density through the particle meter 52, consequently, there is carried out a control for turning ON the electromagnetic valve 42 to blow the air out.

Thus, the air may be blown out through the bar nozzle 30 by an ON/OFF operation depending on the detection of powder dust only when the powder dust is generated. Thus, it is possible to decrease the adverse effects that the air flow moves the mounted device P or the device absorbed at the tip of the holding member.

FIG. 9 shows a surface mounting apparatus according to a third embodiment of the invention.

In a component mounting apparatus according to the third embodiment, an ionizer 54 is provided in a position on a front stage (an inner part) of an injecting hole 30A for blowing clean air out of a bar nozzle 30, and ionized air is thus blown out of the bar nozzle 30.

When mounting a device P onto a substrate S, consequently, the device P and a holding member 50 which are moved downward are caused to pass through a flow of the ionized air. According to circumstances, the device P is temporarily stopped in the flow of the ion air. Thus, the ionized air has the function of removing the charge of the device P. In that case, if there is a possibility that an adsorbing position of the component P might be shifted due to the air flow because of a small size of the component P, a countermeasure may be taken by reducing a blowout pressure of the air.

A component supply device (e.g., a tape and a tray of a tape feeder) is usually formed by an insulator, and a static electricity generated by a friction caused by the feed of the tape feeder is maintained to be charged to the component P and is discharged in a very small amount to the surroundings. In general, the holding member 50 to be adsorbed and mounted is electrically insulated from the mounting apparatus and is maintained in a mechanical floating state. Even if the holding member 50 adsorbs the device, therefore, the charges of the device are not removed.

In the case in which the device is mounted onto a produced substrate in the charging state, therefore, the charges on the device are rapidly discharged to the produced substrate because the substrate S is conductive. In some cases, the device itself is broken by the discharge carried out at this time.

It is possible to neutralize the charges by spraying the ionized air. Therefore, it is possible to prevent the device from being broken. More specifically, by ionizing the clean air, it is possible to have a charge preventing function of the device in addition to a countermeasure taken against powder dust.

While the embodiments of the invention have been specifically described above, the invention is not restricted to the embodiments.

For example, it is also possible to reverse the positional relationship between the bar nozzle 30 and the dust collecting duct 34 which are disposed close to the clamp mechanisms 22A and 22B on the reference and driven sides respectively. Moreover, they are not directly fixed to the struts 10A and 10B of the delivery rails but may be fixed through separate members to cause the clean air to flow above the produced substrate.

Furthermore, the bar nozzle has the structure in which the lateral holes 30A are formed on the hollow pipe member at a regular interval and the clean air is blown from both ends (either of the ends) of the pipe, and the air is thus blown out like a shower (a curtain) almost uniformly from the lateral holes 30A. However, this is not restricted but it is apparent that nozzles having various structures including the shape of the hole may be employed if the same function and performance may be obtained.

Furthermore, if the air blowout and suction may be prevented from being stopped in the downward movement of the holding member to adsorb the component, for example, the ionized air may remove the charges of the nozzle and it is possible to avoid a danger that the device to be adsorbed might be broken with a static electricity. By turning OFF the air when the holding member reaches a lowermost point in which the component is to be adsorbed, it is also possible to avoid the influence of the air on the device in the upward movement.

What is claimed is:

1. A surface mounting apparatus comprising:
a pair of substrate fixing portions, each of the substrate fixing portions being opposed to each other to support and fix opposing ends of a substrate respectively;
a mounting head which is movable in a vertical direction to mount a component on the substrate supported and fixed by the substrate fixing portions;
an air ejecting portion disposed close to one of the substrate fixing portions to eject air like a curtain from an outer side and above an upper surface of the substrate; and
an air suctioning portion disposed close to the other substrate fixing portion so as to oppose to an ejecting direction of the air at an opposite side of the air ejecting portion with respect to the substrate to suction the air from the air ejecting portion.

2. The surface mounting apparatus according to claim 1, wherein the air ejecting portion ejects the air along the upper surface of the substrate.

3. The surface mounting apparatus according to claim 1, wherein the air ejecting portion comprises a hollow cylindrical member having both ends opened;
wherein ejecting holes, from which the air is ejected, are formed on the hollow cylindrical member at predetermined intervals in a longitudinal direction of the hollow cylindrical member;
wherein an air blowout range of the ejecting holes covers the entire upper surface of the substrate supported and fixed by the substrate fixing portions.

4. The surface mounting apparatus according to claim 1, wherein the mounting head comprises a holding member which removable holds the component,
wherein the surface mounting apparatus further comprises a controller which stops an ejection of the air from the air ejecting portion when the holding member is positioned within a blowout range of the air while mounting the component onto the substrate.

5. The surface mounting apparatus according to claim 4, wherein the controller stops the ejection of the air from the air ejecting portion before the holding member passes through an ejection flow of the air from above, and starts the ejection of the air from the air ejecting portion after the component is mounted and after the holding member passes through the ejection flow of the air from below.

6. The surface mounting apparatus according to claim 4, wherein the controller stops the ejection of the air from the air ejecting portion before the holding member is moved downward into the blowout range of the air.

7. The surface mounting apparatus according to claim 4, wherein the controller stops the ejection of the air from the air injecting portion when a movement of the holding member in a horizontal direction is stopped.

8. The surface mounting apparatus according to claim 4, wherein the controller simultaneously stops a suction of the air suctioning portion and the ejection from the air injecting portion.

9. The surface mounting apparatus according to claim 1, wherein at least one of the air ejecting portion and the air suctioning portion is fixed to the substrate fixing portions.

10. The surface mounting apparatus according to claim 1, wherein the air ejects like air curtain from the air ejecting portion.
